(19) United States
(12) Patent Application Publication
(10) Pub. No.: US 2006/0184499 A1
(43) Pub. Date: Aug. 17, 2006

(54) Data search system and method

(75) Inventor: David H. Potter, North Plainfield, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Cibernet Corporation

(21) Appl. No.: 11/055,516

(22) Filed: Feb. 11, 2005

(51) Int. Cl. G06F 17/30

(52) U.S. Cl. 707/1

(57) ABSTRACT

According to some embodiments of the invention, a method of data management is provided. The method includes generating a plurality of sub-tables in a table of a relational database. Each sub-table has a predicate that indicates at least a partial description of information to be stored in the sub-table. The method also includes storing in the plurality of sub-tables one or more records having data. Each record is stored in the sub-table having the predicate that matches at least a portion of the data of the record.

### RELATED APPLICATIONS

This application incorporates by reference the applications entitled “Method and Apparatus for Searching a Database,” attorney docket 9614.0003-00, filed herewith, and “Method and Apparatus for Temporal Database,” attorney docket 9614.0002-00, filed herewith.

### TECHNICAL FIELD OF THE INVENTION

This invention relates generally to information management, and more particularly to a data search system and method.

### BACKGROUND

The amount of information to be maintained continually increases in today's society. For example, in the financial industry, information on various past and present transactions of clients may need to be maintained almost indefinitely. With the need to maintain large amounts of data for a long time, data management, particularly in the area of data search, becomes increasingly difficult. Using electronic databases such as a relational database facilitates data management. But even in a relational database, data management tasks such as data queries may be unreasonably cumbersome and time-consuming if the amount of data stored in the relational database is too large.

In an effort to address this challenge, a data manager may divide the data into different categories and maintain each category of data in a separate relational database. For example, data may be categorized chronologically. In such an example, data may be categorized by months, and data for transactions that occurred in the month of January may be located in a relational database labeled “January,” data associated with transactions that occurred in February may be located in a relational database as “February,” and so forth. Other ways of maintaining data in different databases may include separating the data based on the location of the transaction. For example, information associated with transactions that occurred in New Jersey may be located in a relational database labeled “New Jersey,” and information for data associated with transactions that occurred in New York may be maintained in a relational database labeled as “New York.” Such a database system, however, requires a user who issues a data query to know what data is located in which database. Therefore, to look for information on a particular transaction, a user may have to know when and/or where the transaction occurred so that the correct database may be searched.

### SUMMARY OF THE INVENTION

According to some embodiments consistent with the invention, a method of data management is provided. The method includes generating a plurality of sub-tables in a table of a relational database. Each sub-table has a predicate that indicates at least a partial description of information to be stored in the sub-table. The method also includes storing in the plurality of sub-tables one or more records having data. Each record is stored in the sub-table having the predicate that matches at least a portion of the data of the record.

Some embodiments consistent with the invention provide numerous technical advantages. Some embodiments may benefit from some, none, or all of these advantages. For example, according to one embodiment, data queries are made faster by using sub-tables to divide the data into smaller searchable portions. In another embodiment, a user transmitting the data query is not required to know where and/or how the data is stored and maintained. In another embodiment, multiple processors may be simultaneously used to search through multiple sub-tables, which expedites the data search. Other technical advantages may be readily ascertained by one of skill in the art.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the invention.

### BRIEF DESCRIPTION OF THE DRAWINGS

FIG. 1 is a schematic diagram illustrating one embodiment of a data management environment consistent with the present invention;

FIG. 2 is a schematic diagram illustrating one embodiment of a computing platform that may be used to maintain the relational database shown in FIG. 1;

FIG. 3 is a schematic diagram illustrating a plurality of sub-tables in the table of the relational database shown in FIG. 2;

FIG. 4 is a flow chart illustrating one embodiment of a method for storing data in the sub-tables shown in FIG. 3; and

FIG. 5 is a flowchart illustrating one embodiment of a method for searching through the data that is stored in the sub-tables using the method of FIG. 4.

### DESCRIPTION OF EXAMPLE EMBODIMENTS

Reference will now be made in detail to the embodiments consistent with the present invention, examples of which are illustrated in the accompanying drawings. Wherever possible, the same reference numbers will be used throughout the drawings to refer to the same or like parts.

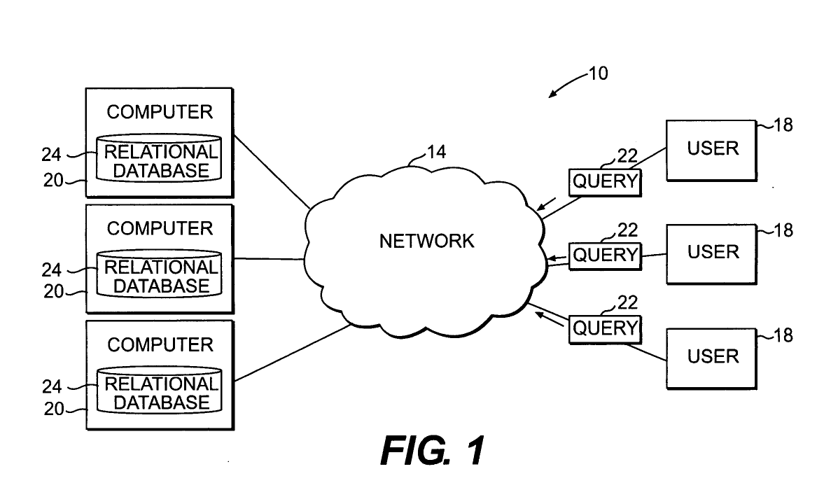

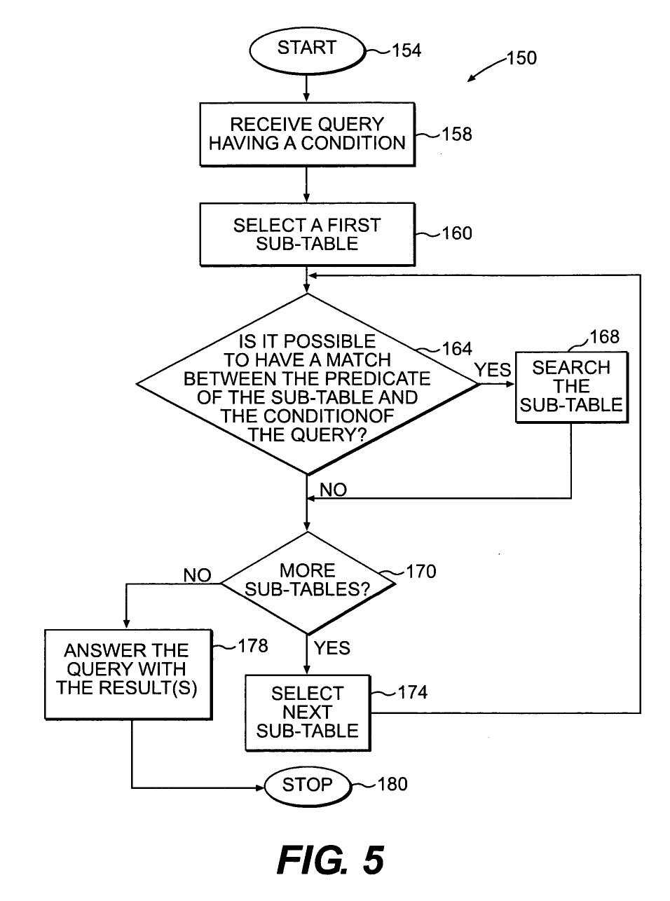

FIG. 1 is a schematic diagram illustrating one embodiment of a data management environment 10 that is consistent with the present invention. Environment 10 comprises a network 14, a plurality of users 18, and a plurality of computers 20 each maintaining at least one relational database 24. Network 14 couples users 18 to computers 20, and allows users 18 to access database 24 in each computer 20 from remote locations. As shown in FIG. 1, a particular user 18 may transmit a query 22 to a particular computer 20. In some instances user 18 may transmit multiple queries 22 to one or more computers 20. Queries 22 may also be automatically generated in some instances. Query 22 includes, for example, a description of the particular type of data being requested and any conditions to be applied in the search. The type of requested information is referred to as a “data attribute.” Additional details describing a “condition” are provided below in conjunction with FIG. 5. After receiving query 22, computer 20 searches through database 24 for information requested by query 22, and computer 20 transmits the result of the search back to user 18.

Although FIG. 1 shows one database 24 maintained in one computer 20, more than one database 24 may be maintained in one computer 20. In some instances, one logical database 24 may be distributed on multiple computers 20. In some instances, database 24 of a particular computer 20 may be in a location remote from the particular computer 20. Although FIG. 1 shows network 14 as communicably coupling users 18 with computers 20, users 18 may be communicably coupled with computers 20 without network 14 in some embodiments. Thus, in some embodiments, network 14 may be omitted. In other embodiments, there may be more than one network 14 that couples user 18 to computer 20. Network 14 may be any suitable network that allows user 18 to communicate with computer 20. Examples of network 14 include, but are not limited to, internets, intranets, wide area networks, local area networks, and metropolitan area networks. User 18 may communicate with computer 20 through network 14 using any suitable computing platform, including, but not limited to, a personal desk top computer, a laptop, a personal digital assistant, and a cellular phone.

When a database, such as relational database 24 shown in FIG. 1, includes a large amount of data, conducting a search through the data may be cumbersome and time-consuming. This problem becomes exacerbated when multiple users 18 try to access database 24 at the same time. To alleviate this problem, one may categorize the data into different categories and each category of data may be stored in a separate database. For example, a first relational database 24 may be used to store data associated with all business transactions that occurred in the month of January, and a second relational database 24 may be used to store all data associated with business transactions that occurred in the month of February, and so forth. Although this approach allows a relatively faster and less cumbersome data searches, it also may require users 18 to have some level of knowledge regarding which database contains the information sought. This potential requirement becomes more problematic when the data storage architecture is changed from time to time by the data administrator in the course of maintaining the data.

According to some embodiments consistent with the invention, a method and system of data management are provided that allow a faster and more efficient data search by segregating the data in a relational database into appropriate sub-tables and searching through only the sub-tables having a potential of including the requested data. Using sub-tables can be advantageous in some embodiments because multiple indexes may be used to index the data stored in the relational database, which allows a more efficient data search. In other embodiments, all the data to be searched through may be stored in a single database and/or a single table, which relieves the user from the requirement of knowing prior to a query which data table contains the requested data. In some embodiments, multiple processors may be used to search through multiple sub-tables during the same search, which, among other advantages, allows a faster data search. Other advantages may be apparent to those skilled in the art.

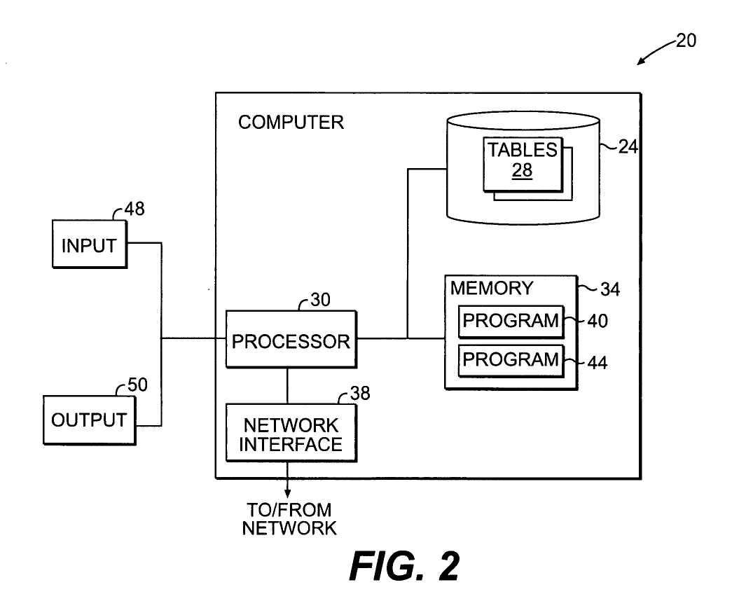

FIG. 2 is a schematic diagram illustrating additional details of computer 20 shown in FIG. 1. Computer 20 comprises relational database 24 storing one or more tables 28, a processor 30, a memory 34 storing programs 40 and 44, an interface 38, input 48, and an output 50. As shown in FIG. 2, processor 30 is coupled to database 24 (stored in a computer-readable medium such as a hard disk or a CD ROM), memory 34, interface 38, input 48, and output 50.

Processor 30 may be any suitable processor that is operable to execute one or more instructions, such as a software program. An example of processor 30 includes, but is not limited to, the PENTIUM series processors available from Intel Corporation. Although one processor 30 is shown in FIG. 2, multiple-processors 30 may be included in computer 20. In some embodiments, multiple processors 30 may be used to perform parallel processing functions. Network interface 38 may be any suitable interface device that allows processor 30 to communicate with a user connected to a network, such as user 18 shown in FIG. 1. Examples of network interface 38 include, but are not limited to, a modem, an Ethernet card, or a serial interface.

Relational database 24 may be stored in a suitable computer readable medium, such as a hard disk drive or a CD ROM. A “relational database” refers generally to a collection of data items organized as a set of described tables from which data can be accessed or reassembled in many different ways without having to reorganize the database tables. Relational database 24 may be managed using a suitable user and application program interface, such as the structured query language (SQL). Each table 28 of relational database 24 may include one or more records (not explicitly shown in FIG. 2). A “record” refers to data associated with a particular entity and/or event, or any other suitable categorization of data. For example, data associated with a particular business transaction can constitute one record. In another example, data associated with information that identifies a client can be one record. Although FIG. 2 shows one relational database 24 in computer 20, in some embodiments, multiple relational databases 24 may be maintained in computer 20.

Input 48 may be any suitable device that is operable to send information to processor 30, such as a keyboard or a mouse. Input may also be automated. Output 50 may be any suitable device that processor 30 may use to communicate with an operator of computer 20, such as a monitor or a printer. Memory 34 may be any suitable storage device that is operable to store one or more programs, such as programs 40 and 44, for access by processor 30. Examples of memory 34 include, but are not limited to, a DRAM, SRAM, and SDRAM.

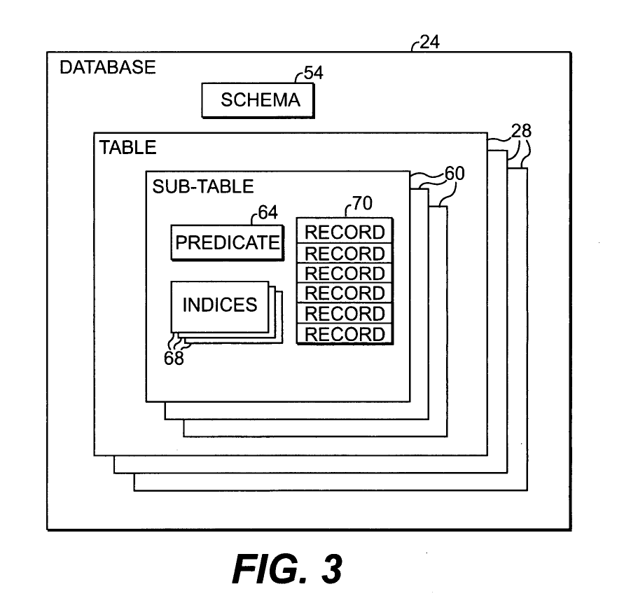

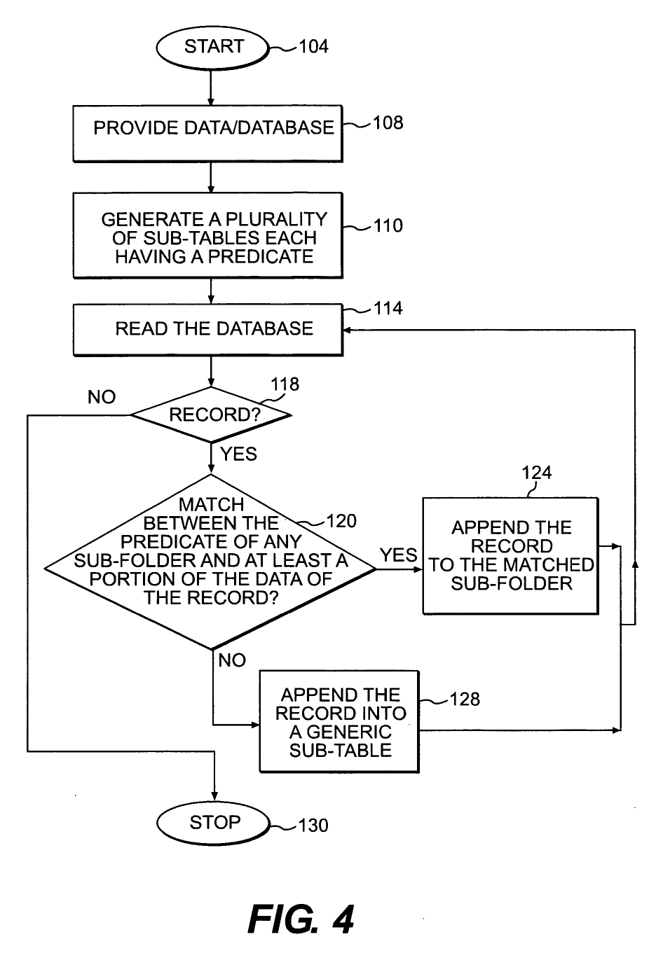

Program 40 is operable to generate sub-tables (not explicitly shown in FIG. 2) each having a predicate, and to store one or more records into a suitable sub-table. Additional details concerning a predicate are provided below in conjunction with FIG. 3. In some embodiments, program 40 is operable to determine that a particular predicate of a sub-table is a closest match to at least a portion of the data of a particular record, and to store the particular record in that sub-table. In some embodiments, program 40 is operable to determine that, compared to one other predicate, a particular predicate of a sub-table is a better match to at least a portion of the data of a particular record, and to store the particular record in that sub-table. Program 44 is operable to receive a query, such as query 22 shown in FIG. 1, to identify those sub-tables that have no possibility of having the data requested by query 22, and to search through only those sub-tables that may possibly include the requested data. Additional details describing programs 40 and 44 are provided below in conjunction with FIGS. 4 and 5, respectfully. Although programs 40 and 44 are shown as two separate programs, in some embodiments, programs 40 and 44 may be implemented as one program or more than two programs. Programs 40 and 44 may be provided using any suitable computer language including, but not limited to, C, C++, or a hybrid of C and C++.

Although FIG. 2 shows relational database 24 and programs 40 and 44 in computer 20, in some embodiments, relational database 24 and/or programs 40 and 44 may be in a location that is remote from computer 20. For example, relational database 24 may be in another computer, and processor may be able to access the relational database 24 through the internet using network interface 38. Although FIG. 2 shows one relational database 24 in computer 20, in some embodiments, multiple databases 24 may be maintained in computer 20.

FIG. 3 is a schematic diagram illustrating additional details of relational database 24 shown in FIG. 2. Database 24 comprises a schema 54 that describes database 24, and each table 28 of database 24 includes one or more sub-tables 60. Each sub-table 60 comprises a predicate 64, one or more indices 68, and one or more records 70. Index 68 describes the information in sub-table 60. A “predicate,” such as predicate 64 of sub-table 60, indicates at least a partial description of information to be stored in the sub-table 60. For example, in some embodiments, if the sub-table 60 is to be used to store records 70 of all transactions with a company named “cibernet,” then predicate 64 may include any portion of the name “cibernet,” including, but not limited to, “cibernet,” “ciber,” “c,” “ib,” “b,” “er,” “t,” and “net.” Although predicate 64 is shown in FIG. 3 as located in sub-table 64, in some embodiments, predicate 64 may be located in schema 54, an auxiliary table, or any other suitable means that can serve as a directory. In some embodiments, sub-tables 60 may be generated using program 40 shown in FIG. 2. In some embodiments, sub-tables 60 may be generated using any suitable program interface, such as SQL, that is used to interface with relational database 24. Other techniques for generating sub-tables 60 will be apparent to those skilled in the art.

In some embodiments, at least one of sub-tables 60 is designated to serve as a sub-table 60 for information that is not matched up with any other sub-table 60. Such a sub-table 60 is referred to as a generic sub-table 60. In some embodiments, generic sub-table 60 lacks a predicate 64. In some embodiments, generic sub-table 60 has a predicate 64, but the value indicated by the predicate 64 may be null or zero. Having generic sub-table 60 is advantageous in some embodiments because if not even a portion of the data of record 70 matches any of predicates 64 of other sub-tables 60, then the record 70 may be stored in generic sub-table 60. In some embodiments, one or more sub-tables 60 may be nested into other sub-tables 60, depending on the particular data structure selected.

FIG. 4 is a flow chart illustrating one embodiment of a method 100 that may be used to segregate data into sub-tables, such as sub-tables 60. Method 100 may be implemented using program 40 shown in FIG. 2. However, any suitable method of implementation may be used to implement a portion or all of method 100. Method 100 is described using the example embodiments consistent with the invention shown in FIGS. 1 through 3. However, any suitable device or a combination of devices that may be used for data management may benefit from method 100.

Method 100 starts at step 104. At step 108, data to be segregated, such as records 70, is provided in relational database 24. Record 70 is used from herein to describe the data provided at step 108. Records 70 may be, for example, in table 28 of relational database 24 shown in FIG. 3, or in an existing sub-table 60 of relational database 24. At step 110, sub-tables 60 each having predicate 64 are generated using program 40. In some embodiments, at step 110, at least one generic sub-table 60 associated with predicate 64 that has a zero-value or a null value is also generated. In other embodiments, at step 110, at least one generic sub-table 60 that does not have predicate 64 may be generated. At step 114, program 40 reads database 24.

At decision step 118, program 40 determines whether there are any records present in database 24 that have not been segregated into sub-tables 60. If yes, then the “yes” branch is followed to decision step 120, where program 40 determines whether there is match between predicate 64 of any sub-table 60 and at least a portion of the data in a non-segregated record 70 that is determined to be present at step 118. In some embodiments, program 40 determines that, out of all predicates 64 of sub-tables 60, a particular predicate 64 of a particular sub-table 60 is the closest match to the data of record 70. For example, record 70 may have a character string of “David Potter,” and the particular predicate 64 has the most equal characters as “David Potter” may be determined as the closest match to the string “David Potter.” For instance, a first predicate 64 may have a value of “Potter,” a second predicate 64 may have a value of “P,” and a third predicate 64 may have a value of “D Potter.” In such a scenario, the third predicate 64 is the closest match to the record 70 having a character string of “David Potter” because it has the most equal characters as the character string of “David Potter.” If the third predicate 64 had a value of “a Potter,” it is still the closest match because it has the most equal characters as “David Potter.” In some embodiments, the order of the characters in a character string may also be used to determine the closest match. For example, “Potter” is a better match to “David Potter” than “Pottre.”

Rather than selecting the closest match, in some embodiments of the invention, at step 120, program 40 may select as a match a predicate 64 that is a better match to the data of record 70 than one other predicate 64. For example, where record 70 comprises a character string of “David Potter,” a first predicate 64 having a value of “D Potter” is a better match to “David Potter” than a second predicate 64 having a value of “Potter” and thus may be selected, even if there is another predicate 64 that has a value that is a closer match to the character string of “David Potter.”

In some embodiments, at step 120, if there are more than one predicate 64 that match the portion of record 70, then program 40 may select one of the matching predicates 64 that is associated with a sub-table 60 that has the lowest probability of being selected to be searched in a query. In other words, among the matching predicates 64, the predicate 64 of sub-table 60 having the highest likelihood of being skipped in a data query is selected as the matching predicate 64 of step 120. In such embodiments, program 40 is operable to access the statistics associated with each sub-table 60 on what query conditions resulted in the exemption of that sub-table 60 from being searched during a query, and using such statistics, determine the likelihood of a sub-table 60 being searched or skipped. Other ways of making a determination of the likelihood of being skipped in a data search may be used by one skilled in the art.

An example of the such embodiments is described below using an example scenario where users of a relational database 24 more often access current data rather than archived data, and a first sub-table 60 is determined to have been searched less often than a second sub-table 60 for data queries because, for example, the first sub-table 60 has more archived data than the second sub-table. Any suitable time limit may be used to distinguish current data from archived data (data more than two months old may be archived data, and data that is not archived is current data, for example). In such an example scenario, if record 70 includes character string “Potter,” predicate 64 of the first sub-table 60 has a value of “Pot,” and predicate 64 of the second sub-table 60 has a value of “ter,” then program 40 selects predicate 64 of the first sub-table 60 at step 120 because the first sub-table 60 has been searched less in previous queries.

In some embodiments, the selection of a matching predicate 64 may be made by program 40 regardless of the level of match (a closest match or a better match, for example) between the portion of the data of record 70 and predicate 64. Referring again to the example scenario described above, in some embodiments, even when predicate 64 of the first sub-table 60 is a worse match to the data of record 70 than predicate 64 of the second sub-table 60, predicate 64 of the first sub-table 60 may be selected as the matching predicate 64 because the first sub-table 60 has a higher likelihood of being skipped in a search for data. For example, predicate 64 of the first sub-table 60 may be selected even if predicate 64 has the value “P” rather than “Pot,” which is a worse match to the character string “David Potter” than the predicate 64 of the second sub-table 60. In some embodiments, the criteria for the selection of a matching predicate 64 at step 120 may include various combinations of the example criteria discussed above. For example, a closest matching predicate 64 that has the highest likelihood of being skipped in a data search may be selected as the matching predicate 64 of step 120.

Referring again to decision step 120, if program 40 determines that there is a suitable match, then the “yes” branch is followed to step 124 where program 40 appends the record 70 into the sub-table 60 that is associated with the matching predicate 64 of step 120. Then method 100 proceeds back to step 114. If no match, then the “no” branch is followed to step 128 where program 40 appends the record 70 into generic sub-table 60. Then method 100 proceeds back to Step 114. Referring back to decision step 118, if no non-segregated record 70 is present, then the “no” branch is followed to Step 130. Method 100 stops at Step 113.

In some embodiments, steps 108 and 110 may not need to be performed because database 24 and sub-tables 60 already exist. Thus, steps 108 and 110 may be omitted. In some embodiments, data to be segregated may be provided directly by an operator who inputs data to be stored in database 24. Thus, records 70 may be segregated into appropriate sub-tables 60 on a near-real-time basis as they enter database 24.

FIG. 5 is a flow chart illustrating one embodiment of a method 150 consistent with the present invention for searching through the data, such as records 70, stored in sub-tables 60. Method 150 may be implemented using program 44 shown in FIG. 2. However, any suitable method of implementation may be used to implement a portion or all of method 150. Method 150 is described using the example embodiments of the invention shown in FIGS. 1 through 3. However, any suitable device or a combination of devices that may be used for data management may benefit from method 150.

Method 150 starts at step 154. At step 158, program 44 receives query 22 (shown in FIG. 1) having a condition. A “condition” refers to a search condition that describes some category of data that is requested. For example, an example data query may request addresses and phone numbers of a person named “David Potter.” The “addresses” and the “phone numbers” are the “attributes” of the query, and “David Potter” is the condition of the query. But in some embodiments of the invention, query 22 may not have a condition. At step 160, a particular sub-table 60 is selected. At decision step 164, program 44 determines whether it is possible to have a match between the predicate 64 of the sub-table 60 selected at step 160 and the condition of the query. A match is considered to be “possible” where a condition has a chance of being equal to a predicate. For example, if the condition of query 22 is Name=“David Potter,” and predicate 64 only indicates a value of Residence=“New Jersey,” then a match is considered to be “possible” because predicate's 64 value does not directly contradict the condition of query 22. However, where predicate 64 indicates a value of Name=“John Doe,” a match is considered to be not “possible” because the Name value cannot be both “David Potter” and “John Doe.”

Referring again to decision step 164, if a match is possible, then the “yes” branch is followed to step 168 where the selected sub-table 60 is searched for the requested data. Then method 150 proceeds to decision step 170. Referring again to decision step 164, if a match is not possible, then the “no” branch is followed to decision step 170 where program 44 skips the selected sub-table 60 of step 160 and determines whether there are any more sub-tables 60 that may be searched. If yes, then “yes” branch is followed to step 174 where program 44 selects another sub-table 60. Then method 150 proceeds back to decision step 164. If no, then the “no” branch is followed to step 178 where program 44 answers the query 24 with the results of the search. Method 150 stops at step 180.

Other embodiments of the invention will be apparent to those skilled in the art from consideration of the specification and practice of the invention disclosed herein. It is intended that the specification and examples be considered as exemplary only, with a true scope and spirit of some embodiments of the invention being indicated by the following claims.

What is claimed is:

1. A method of data search, comprising:
generating a plurality of sub-tables in a table of a relational database, each sub-table having a predicate that indicates at least a partial description of information to be stored in each sub-table;
storing in the plurality of sub-tables one or more records having data, wherein each record is stored in one of the sub-tables having the predicate that is, among the predicates of all of the sub-tables, a closest match to at least a portion of the data of the record;
receiving a query having a condition to be used in a search of the sub-tables;
determining whether a match between the predicate of a first one of the sub-tables and the condition is possible;
if the match is possible, then searching the first one of the sub-tables for at least one stored record that matches the condition and answering the query using a result of the search; and
if the match is not possible, then without searching the first one of the sub-tables, determining whether a match between the predicate of a second one of the sub-tables and the condition is possible.

2. The method of claim 1, and further comprising:
generating a sub-table having no predicate; and
storing in the sub-table having no predicate any one of the records having data that does not at least partially match any of the predicates of the plurality of sub-tables.

3. The method of claim 1, wherein storing in the sub-tables one or more records having data comprises storing in the sub-tables one or more records that are stored in another table.

4. The method of claim 1, and further comprising:
determining that at least two of the sub-tables each have the predicate that is a possible match with the condition; and
searching the at least two of the sub-tables for a record that matches the condition using two or more processors operating in parallel for at least a portion of the search.

5. A method of data management, comprising:
generating a plurality of sub-tables in a table of a relational database, each sub-table having a predicate that indicates at least a partial description of information to be stored in the sub-table; and
storing in the plurality of sub-tables one or more records having data, wherein each record is stored in one of the sub-tables having the predicate that matches at least a portion of the data of the record.

6. The method of claim 5, wherein the one of the sub-tables comprises the predicate that is, among the predicates of the sub-tables, the closest match to at least a portion of the data of the record.

7. The method of claim 5, wherein the one of the sub-tables comprises the predicate that is, as compared with the predicate of another one of the records, a better match to at least a portion of the data of the record.

8. The method of claim 5, and further comprising generating a sub-table having no predicate.

9. The method of claim 5, wherein at least one of the sub-tables has the predicate having a null value.

10. The method of claim 5, wherein at least one of the sub-tables has the predicate having a value of zero.

11. The method of claim 5, and further comprising:
receiving a query having a condition to be used in a search of the sub-tables;
determining whether a match between the predicate of a first one of the sub-tables and the condition is possible;
if the match is possible, then searching the first one of the sub-tables for at least one stored record that matches the condition and answering the query using a result of the search; and
if the match is not possible, then without searching the first one of the sub-tables, determining whether a match between the predicate of a second one of the sub-tables and the condition is possible.

12. The method of claim 11, and further comprising:
generating a sub-table having no predicate; and
storing in the sub-table having no predicate any one of the records having data that does not at least partially match any of the predicates of the plurality of sub-tables.

13. The method of claim 5, and further comprising:
receiving a query having a condition to be used in a search of the sub-tables;
determining that at least two of the sub-tables each have the predicate that is a possible match with the condition; and
searching the at least two of the sub-tables for a record that matches the condition using two or more processors operating in parallel for at least a portion of the search.

14. The method of claim 5, wherein storing in the plurality sub-tables one or more records having data comprises storing in the plurality of sub-tables one or more records that are stored in another table.

15. An apparatus for data management, comprising:
a computer-readable medium; and
a program stored in the computer-readable medium, the program, when executed by a processor, operable to:
generate a plurality of sub-tables in a table of a relational database, each sub-table having a predicate that indicates at least a partial description of information to be stored in the sub-table; and
store in the plurality of sub-tables one or more records having data, wherein each record is stored in one of the sub-tables having the predicate that matches at least a portion of the data of the record.

16. The apparatus of claim 15, wherein the one of the sub-tables comprises the predicate that is, among the predicates of the sub-tables, the closest match to at least a portion of the data of the record.

17. The apparatus of claim 15, wherein the one of the sub-tables comprises the predicate that is, as compared with the predicate of another one of the records, a better match to at least a portion of the data of the record.

18. The apparatus of claim 15, wherein the program is further operable to generate a sub-table having no predicate.

19. The apparatus of claim 15, wherein the program is further operable to:
receive a query having a condition to be used in a search of the sub-tables;
determine whether a match between the predicate of a first one of the sub-tables and the condition is possible;
if the match is possible, then search the first one of the sub-tables for at least one stored record that matches the condition and answer the query using a result of the search; and
if the match is not possible, then without searching the first one of the sub-tables, determine whether a match between the predicate of a second one of the sub-tables and the condition is possible.

20. The apparatus of claim 19, wherein the program is further operable to:
generate a sub-table having no predicate; and
store in the sub-table having no predicate any one of the records having data that does not at least partially match any of the predicates of the plurality of sub-tables.

21. The apparatus of claim 15, and further comprising:
receive a query having a condition to be used in a search of the sub-tables;
determine that at least two of the sub-tables each have the predicate that is a possible match with the condition; and
search the at least two of the sub-tables for a record that matches the condition using two or more processors operating in parallel for at least a portion of the search.

22. The apparatus of claim 15, wherein the program is operable to store in the plurality sub-tables one or more records having data by storing in the plurality of sub-tables one or more records that are stored in another table.

23. The method of claim 15, wherein at least one of the sub-tables has the predicate having a null value.

24. The method of claim 15, wherein at least one of the sub-tables has the predicate having a value of zero.
